(19) United States
(12) Patent Application Publication
(10) Pub. No.: US 2010/0300098 A1
(43) Pub. Date: Dec. 2, 2010

(54) SOLAR ENERGY POWERED MOLECULAR ENGINE

(76) Inventors: Franklin D. Hwang, Glendora, CA (US); Ching Ching Huang, Glendora, CA (US); Jennifer Peng, Huntington Beach, CA (US); Francis Hwang, Glendora, CA (US); Francine Hwang, Rancho Palos Verdes, CA (US)

Correspondence Address: Franklin D. Hwang, 949 E. Plymouth Ct, Glendora, CA, 91740, US

(21) Appl. No.: 12/684,919

(22) Filed: Jan. 9, 2010

Related U.S. Application Data
(60) Provisional application No. 61/217,089, filed on May 26, 2009.

(51) Int. Cl. F03G 6/00; B23K 26/00

(52) U.S. Cl. 60/641.14; 219/121.71

(57) ABSTRACT

The sun imparts 174 petawatt per second on the earth, and a large portion of this energy is absorbed by the earth's atmosphere in the form of translational energy for the gaseous molecules, i.e. continuous random motion in the average speed range of 500 meters per second on earth's surface. This invention utilizes a partition with large number of through-holes which all have the characteristic of providing greater cross section for gas molecules to transit from one side to the other than the reverse, thus creating a higher statistical probability for the molecules to move from one side of the partition to the other side. By stacking a number of such partitions to emphasize the direction of movement probability of the gas molecules within a container having two open ends, the number of gas molecules at the end of the stack will be more numerous than at the head, creates a pressure differential, and this can be used to push against the stacks of the partition to provide thrust on the container or to drive a turbine to generate electricity or to perform wide variety of works that are done with internal combustion engine. This invention can use solar energy without photovoltaic conversion or large solar farm to concentrate solar radiation, and it replaces all fossil fuels as the current principle energy source, drastically reducing fossil burning and pollutant generation as well as being a critical means by which to arrest global warming trends.

### RELATED APPLICATIONS

This utility application claims the benefit of U.S. Provisional Patent Application No. 61/217,089 filed on May 26, 2009.

### FIELD OF THE INVENTION

This invention utilizes the abundant solar energy received by the planet earth, in the form of translational motion of atmospheric molecules, and creates a pressure differential between two ends of a specially designed stack of permeable partitions to perform meaningful work, dramatically reducing the dependence on fossil fuels and alleviating or reversing the environmental damages due to the combustion of fossil fuels.

### BACKGROUND OF THE INVENTION

Earth continuously receives 174 petawatts (1.74×10¹⁵ watts) per second of incoming solar radiation (insolation) at the upper atmosphere. Not all the 174 petawatts arrive at the earth's surface, 6 percent of the insolation (10 petawatts) is reflected back to space, 16 percent is absorbed (28 petawatts), average atmospheric conditions (clouds, dust, pollutants) further reduce insolation traveling through the atmosphere by 20 percent (35 petawatts) due to reflection and 3 percent via absorption (5 petawatts). Roughly, every second there are 96 petawatts of solar energy reaching the earth's surface. The result is an approximate 3,850 ZettaJoules (ZJ), i.e. 3.85×10²¹ joules, of solar energy per year hitting the surface with land mass receiving 1,000 ZJ. The total energy consumption for the entire world during 2004 was 0.471 ZJ. It is obvious human society can really prosper without the detriments derived from the usage of fossil fuel, if they can utilize this abundance of solar energy efficiently.

Photovoltaic conversion of solar energy and direct conversion of sun light into thermal energy are the two most common means employed to derive energy from the sun. However, both methods depend on sunlight to generate power and, therefore, can not produce energy or electricity half of the time. Areas with cloudy/rainy weather greatly reduce the viability (as well as increase the costs) of either method to produce energy as total alternative to fossil fuels.

The present invention is based on two facts: (1) more than 1,300 ZJ per year is absorbed by the earth's atmosphere, (2) the absorbed energy powers the motion of atmospheric molecules regardless of whether there is sunlight or not. This invention creates a statistically higher probability in a specific direction of flow for the continuous moving atmospheric molecules by providing a larger cross section for molecules to pass through a stack of partitions having funnel shaped through-holes than the reverse direction of movement. As a consequence, a pressure differential is created between the two ends of this stack of partitions. With this pressure difference, various thrust devices, turbines and compressors can be driven to produce propulsion, electricity, refrigeration and numerous other work applications.

Thorough search of prior arts in patents, patent applications and literatures, indicates that power generation by solar means can be categorized as converting solar radiation into electricity directly (photovoltaic approach) or into heat to move a fluid (liquid or gas) at high speeds to rotate a turbine to produce electricity. None of those prior arts incorporate the basic concept of our invention. Only two prior patents (U.S. Pat. No. 6,167,704 on Jan. 2, 2001 and U.S. Pat. No. 6,962,052 on Nov. 8, 2005, both by Goldenblum) have been found utilizing particle movement as an energy source. Goldenblum has claimed the usage of unidirectional stoppers, unidirectional gates (molecular size) and unidirectional elements to selectively block particles (in gas and liquid) with kinetic energy traveling in a direction opposite to a specified one. Special emphasis of these two patents was placed on constructed molecular gates and stoppers to actively reject and stop movement of particles from one direction vs. the opposite; while our invention simply utilizes the physical configurations of a series of bidirectional through-holes on partitions to provide a difference in translational cross sections for gas molecule movement, and through this difference achieve a preferred direction of gas flow. In our invention, there is no selective blocking or using any other form of external energy to block the movement of certain molecules or open and shut molecular gates (as claimed in Goldenblum's patents). Furthermore, the system specified by Goldenblum is a closed one with its fluid separated from any external fluid while obtaining energy through heat exchanges. Our invention only applies to an open atmospheric system.

Our invention complies fully to the laws of thermodynamics as well as fundamental physics by utilizing immovable through-holes to provide a transition cross sectional difference to the atmospheric molecules passing through a partition. No external energy is required to open or close the through-holes.

### SUMMARY OF THE INVENTION

This invention utilizes a partition with a large number of through-holes which all have the characteristic of having greater cross section for atmospheric gas molecules to transit from one direction than the reverse, thus creating a higher statistical probability for the molecules to move from one side of the partition to the other side than the reverse. By stacking a number of such partitions within a container having two open ends, the number of gas molecules that tend to move toward and congregate at the end of the stack will be higher than those doing the reverse, thus a pressure differential is established between the head of the stack vs. the end, and this pressure difference is used to push against the stacks of the partition to provide thrust on the container or to drive a turbine to generate electricity to achieve work.

### BRIEF DESCRIPTION OF THE DRAWINGS

FIG. 1 illustrates the basic concept of this invention in a very simple two-dimensional rectangular box. Within it, a partition with a single funnel shaped through-hole (i.e. hole has large opening diameter on top and tapers down to a stem with much smaller end hole as shown) divides the box into two halves A and B. When a ball with its diameter smaller than the diameter of the end hole undergoes continuous movement at a fixed velocity and perfect elastic collisions with the walls, it will spend more time in the A half having the larger funnel opening. This is due to the fact that the larger cone opening actually limits the entry angle for the ball to bounce through to the bottom end hole than when the ball transits from the opposite direction.

FIG. 2 alters the configuration of FIG. 1 by adding more funnel shaped holes on the partition. This will enhance the dwell time of the ball on the half having the side of larger funnel openings.

FIG. 3 further modifies the configuration of FIG. 2 with additional partitions with multiple funnel shaped through-holes as well as more balls introduced. A software written to simulate this configuration based on simple rules of: (1) perfect elastic collisions between balls and between balls with the walls, i.e. angle of incidence is equal to angle of exit; (2) conservation of momentum; (3) the range of diameters of funnel top and stem end-hole openings are multiple times of the diameter of the ball; (4) the balls travel at a speed ranging from several multiples of the dimension of the rectangular box to several hundred times per second. This software demonstrates that after a period of time of allowing the balls to move around, there will be a gradient established in terms of the number of balls in each compartment defined by partitions as illustrated in FIG. 4. For example, the bottom compartment in FIG. 4 has the most balls, and the compartment above it has less and so on with the compartment just beneath the top one having the least number of balls (the top compartment, i.e. head of the stack, has slightly more than the compartment immediately beneath it due to the fact that there are only one set of through-holes to exit instead of two exit channels for each compartment beneath it). By substituting the balls with atmospheric molecules (oxygen and nitrogen) and opening up both ends of the box, FIG. 4 becomes a gas compressor, in which 1 atmospheric air molecules are being compressed to higher than 1 atmospheric pressure.

FIG. 5 presents a photograph showing an actual 1-micron diameter taper hole drilled by pulsed diode pumped UV laser on a stainless steel substrate. These dimensions of holes can be routinely drilled by pulsed diode pumped lasers on a variety of materials for pin-hole cameras or liquid orifice applications. Furthermore, by adjusting the laser pulse width and repetition rate, one can achieve a hole having various taper angles to virtually no taper (i.e. straight wall).

A potential fabrication process for our invention, the molecular engine, is illustrated by FIGS. 6, 7, 8A and 8B. The initial step shown in FIG. 6 is to have large number of tapered holes drilled on a substrate by multiple high repetition rate diode pumped pulsed UV lasers through a two-step procedure (only one laser is shown for clarity), which first achieves a straight through-hole to form the stem then a different pulse rate and width to achieve the top taper portion at a specified incline angle. The substrate is rotated at a speed matching the hole drilling rate of the lasers while the lasers are individually moved on separate slides to drill a densely packed spiral pattern of through-holes on to the substrate.

The second step as shown in FIG. 7 is to conduct vapor deposition (such as Chemical Vapor Deposition, Plasma Enhanced Chemical Vapor Deposition, Sputtering Deposition or electric discharge formation of nanolayers) in a vacuum chamber to achieve uniformed deposition of another material on to the substrate to reduce each hole diameter to a desired dimension, such as 0.05 micron or less for the stem portion (shown in the before and after inserts of FIG. 7). The third step contains two sub-steps as illustrated in FIGS. 8A and 8B dicing the large substrate with coated through-holes into multiple partitions of specified dimensions to fit into containers of various sizes and shapes along with assembling the container with an air intake controller to form a solar energy powered molecular engine.

FIG. 9 illustrates a mechanical device to control the aperture opening to regulate the amount of air entering into the space above the head of the stack of partitions, thus controlling the amount of pressure difference that can be produced by this molecular engine.

FIG. 10 shows how this invention can be used as a thrust device to levitate and propel a vehicle along with its usage in steering and braking the vehicle. FIG. 11 presents how this thrust device can be combined with burning of liquid fuel to increase thrust for aviation and military applications. FIG. 12 illustrates a vertical take-off and landing aircraft using the molecular engine for levitation while using fuel powered jet engines for propulsion.

FIG. 13 provides the concept drawing of a mobile home that can levitate and be moved based on the invention.

FIG. 14 illustrates how this molecular engine can be used to generate AC (or DC) electricity.

FIG. 15 shows how this molecular engine can be used as a crane to lift weight or as an elevator to move people or objects.

### DETAILED DESCRIPTION OF THE INVENTION

The basic concept of this invention can best be described by the following sequential scenarios:

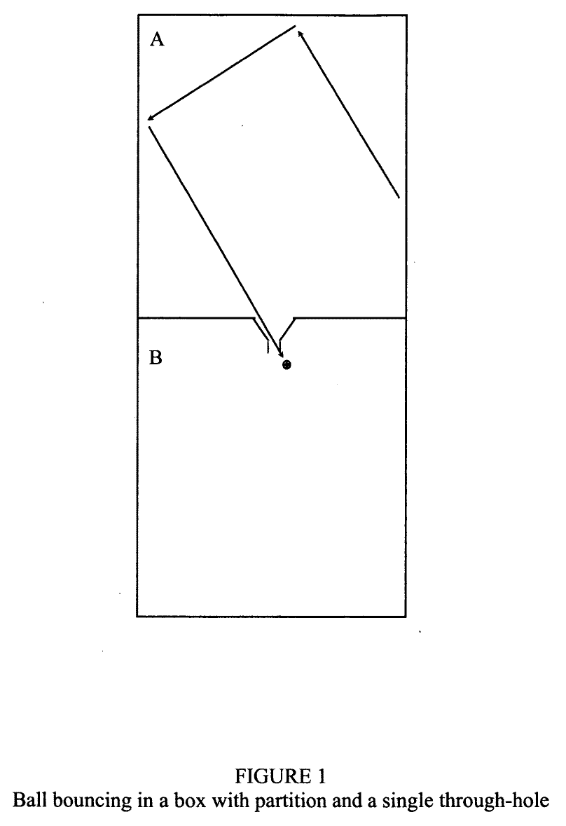

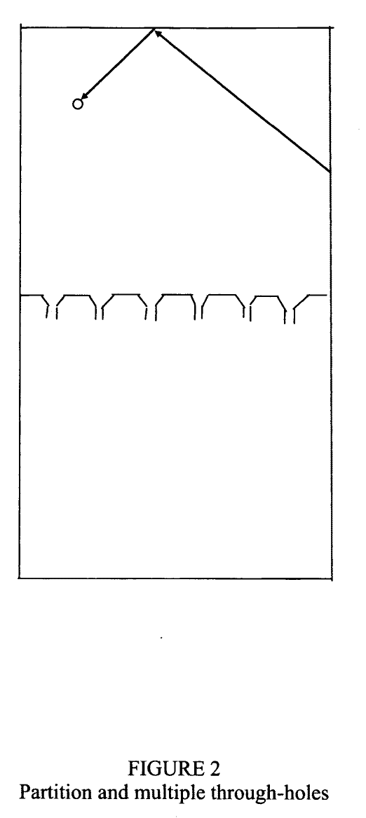

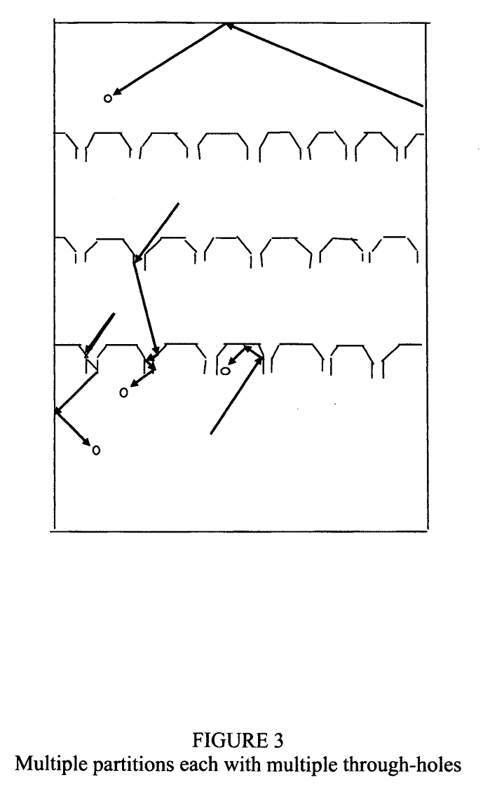

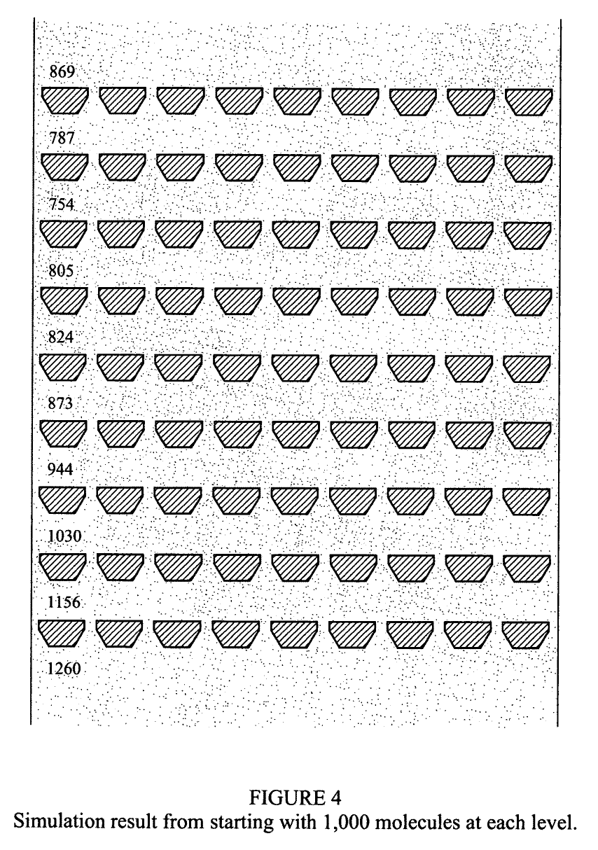

1. In a 2-dimensional rectangle, a partition is inserted in the middle to separate the rectangle into two equal halves. A straight through-hole is added to this partition to allow any perfectly elastic bouncing ball to pass through. When a ball with a finite velocity and with a diameter smaller than the hole is injected into this rectangle, it will bounce from one half to another through the hole. After a sufficient time period, one will find the ball will spend equal time on the two halves of the rectangle.
2. Instead of a 2-dimensional rectangle, a 3-dimensional rectangular box is replacing the rectangle. A partition of certain thickness with a right size of round through-hole having straight side (non-tapered) wall is inserted into the middle of this sealed box and a single perfectly elastic ball is injected into the box with a fixed velocity. In an ideal situation, the ball will be colliding with the walls while maintaining its momentum and speed. After a finite time period, the ball will pass through the hole in the partition numerous times and spend equal time on the two halves of the box.
3. Altering the second scenario by changing the round and straight through-hole with a hole shaped like a funnel with the smaller opening of the stem end just larger than the diameter of the ball, then the ball is likely to spend more time on the half with large cone shaped opening than the side with the smaller opening. The reason is the ball will have a larger cross section (higher probability) to have the correct incidence angles (up to 180°) to enter into the cone from the side with the smaller diameter end of the funnel stem and exit the partition to the other half than from the larger cone opening of the funnel side (which was reduced from 180° due to the funnel top inclining side angle). This scenario is illustrated in FIG. 1.
4. Now, let us introduce more elastic balls into the box. For the second situation (with round non-tapered through-hole), the balls will spend equal time on the two halves. In other words, at any give time, there are likely equal numbers of balls in the two halves. However, for the third scenario (with funnel shaped through-hole), one will find that the balls will spend more time on the side with larger diameter opening of the through-hole. Consequently, at any given time, one will find more balls on the side with larger diameter opening. However, in this closed system, the more balls accumulated in the half with the larger diameter opening of the through-hole, will eventually increase the amount of balls going the other way to reach an equilibrium with one half having more balls than the other, i.e. the difference in number of balls in the two halves is in inverse ratio (top half A has more than the bottom half B per FIG. 1) to the transit cross section difference.
5. Instead of balls, let us consider the atmospheric molecules (nitrogen and oxygen). Those molecules will be colliding with each other and with the walls of the box constantly due to the thermal energy impinged on earth by the sun. At the temperature range on earth (sea level to a couple of thousand feet of altitude), the gas molecules have a speed of around 500 meters per second and behave very much like perfectly elastic balls when colliding with each other and with most solid surfaces, such as smooth container walls. The higher the temperature, the more translational energy (thus higher speed) the molecules will move, and the more they will behave like perfectly elastic balls bouncing around. With the diameters of the funnel shaped hole opening and stem equaling to a few times of the mean free-path length (distance traveled by a molecule before encountering a collision with either another molecule or a wall surface), the more molecules will be aggregated at the half of the box with the larger through-hole opening. Since more bouncing molecules means higher collisional force exerted on the partition and the surrounding walls, a pressure differential results between the two halves.
6. Instead of just one opening, let us have millions of such funnel shaped through-holes on the partition of the box as illustrated by FIG. 2. At any given time, more molecules will be bouncing around in the half of the box with the larger through-hole opening than the other half, thus a pressure differential is created.
7. Instead of just one partition with millions of funnel shaped through-holes, we will have multiple partitions within a closed ended box as shown in FIG. 3. We, then, will have a continuous pressure gradient building up with each partition experiencing a pressure difference between its two sides. For an open ended box, the molecules will flow in from the head of the stack and move through the partitions continuously. At each and the final partition, the partition only experiences a small pressure difference between its two sides, although the cumulative pressure difference between the first the final partitions will be large. With the box open on both ends, this partitioned box creates a pressure difference between 1 atmosphere at one end and larger than 1 atmosphere pressure on the other end, i.e. an atmospheric gas compressor is formed.
8. This large pressure difference will force the box to move toward the 1 atmosphere pressure end or the high pressure end can be exhausted to turn a turbine. Therefore, a thrust device is created or an electricity generator can be built with it or by allowing the compressed gas to expand rapidly to effect cooling and forms a refrigeration unit.

In FIG. 4, results of injecting 10,000 gas molecules into a closed rectangular box with 9 partitions having funnel-shaped through-holes in the partitions (each layer starts out with 1,000 molecules) are illustrated. The diameter of a through-hole and its inclining wall angle will have an effect on the transit cross sections from opposite sides of the hole, thus influencing the efficiency of creating a pressure differential and the magnitude of such pressure difference. Furthermore, considerations must be given to the space between partitions and various methods of controlling air intake into the system to increase its efficiency.

By adding an air intake volume regulating device, such as a mechanical accordion type of cover plate shown in FIG. 9, one can regulate the amount of air delivered to the head of the stack and subsequently regulates the amount of thrust that can be delivered by this engine to perform work.

The critical step in manufacturing this type of molecular engine is the fabrication of the partition with funnel shaped or other types of through-holes that provides a higher statistical probability for atmospheric molecules to transit from one direction vs. the reverse. Here, a specific example as covered in one of the embodiments is given on the fabrication method of a stainless steel partition with rows of funnel shaped through-holes along with subsequent assembling procedure to make the molecular engine described in the previous paragraph. Other manufacturing methods are presented in the Claim section to fit the type of through-holes used.

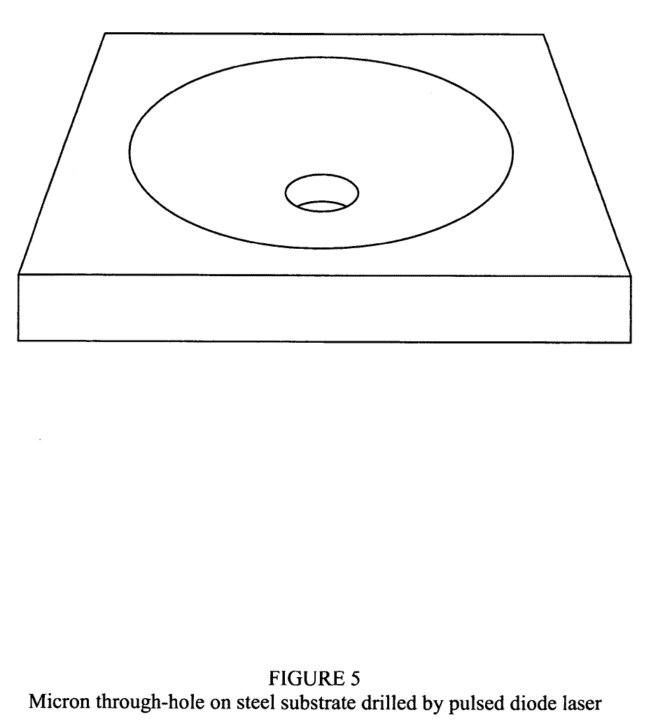

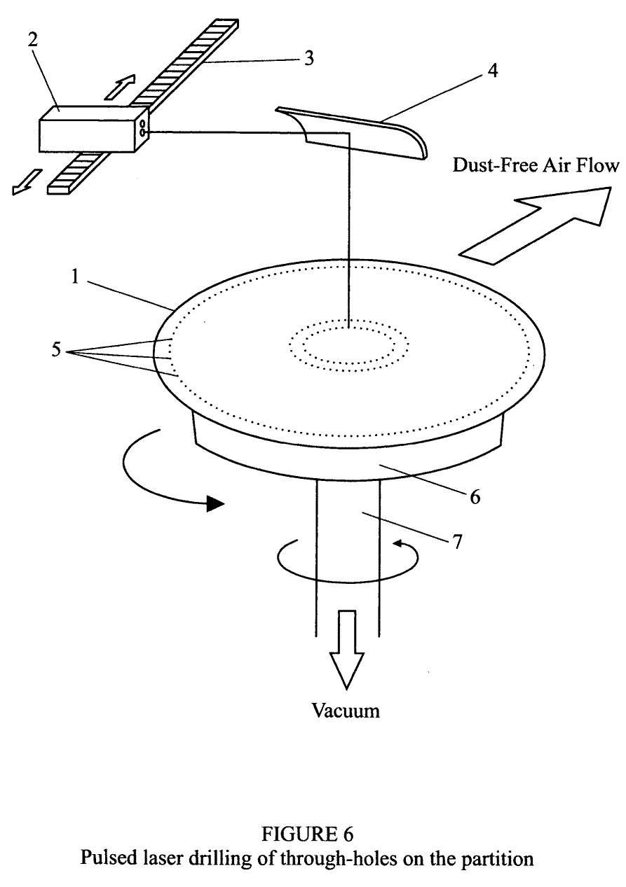

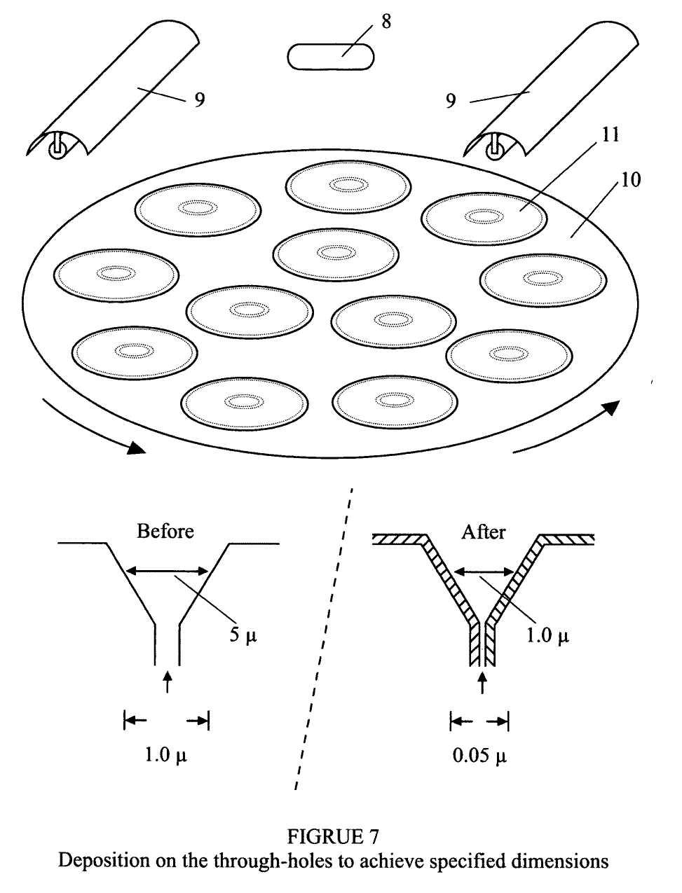

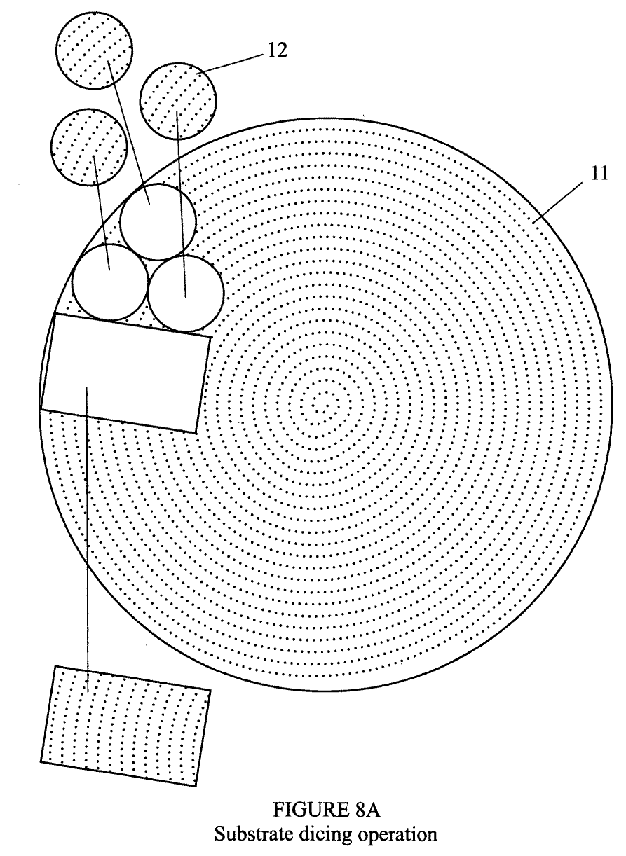

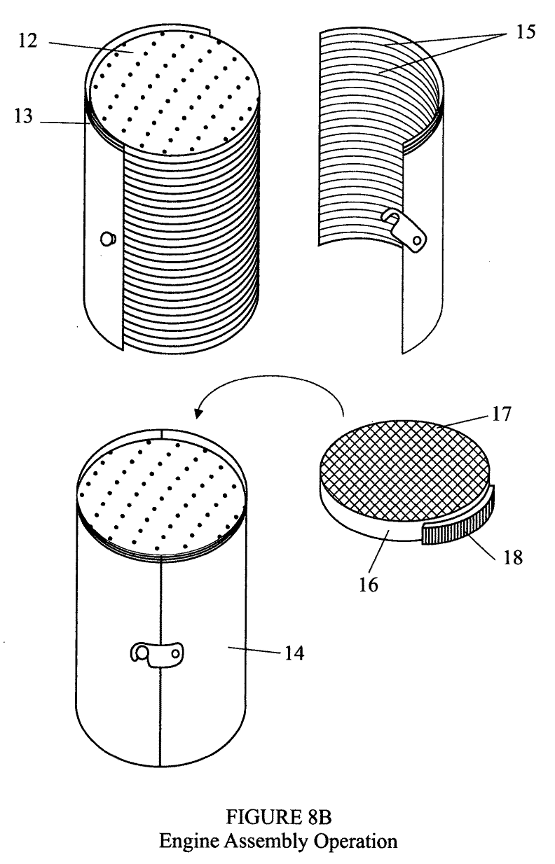

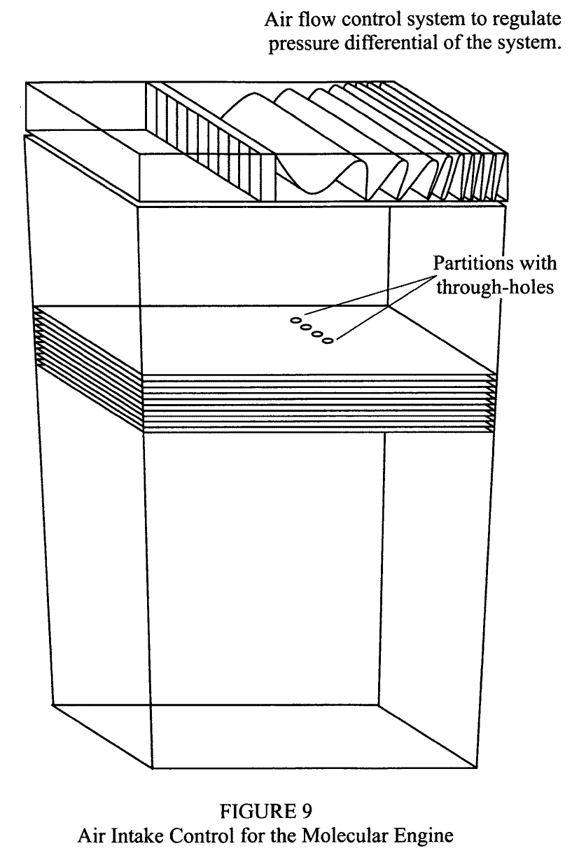

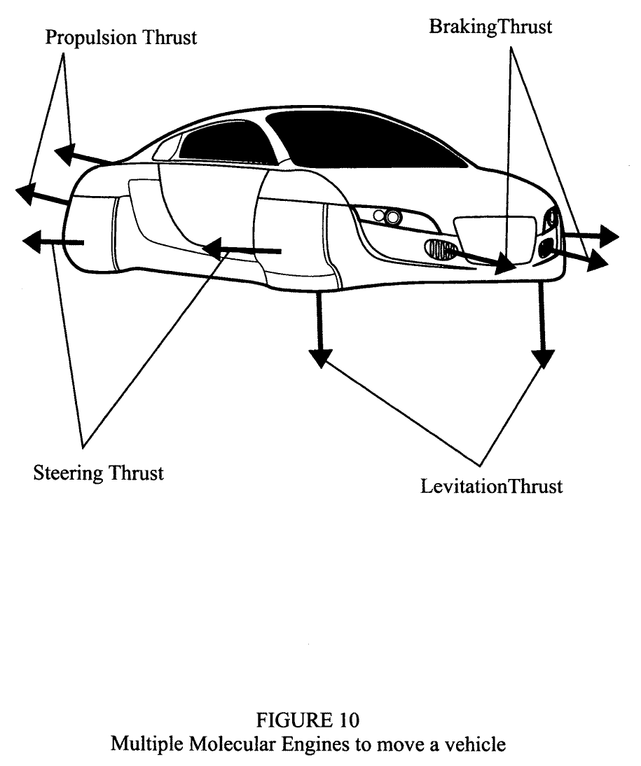

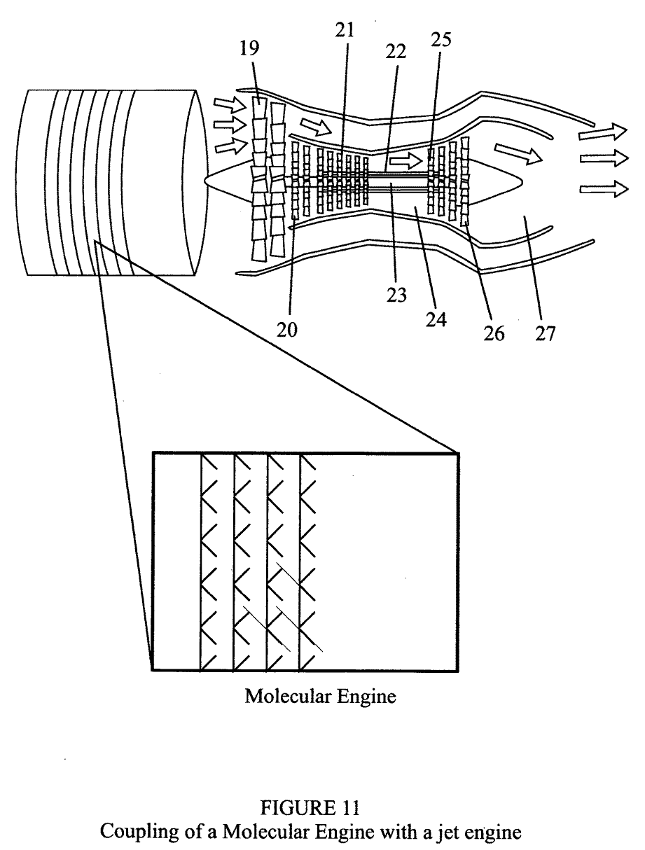

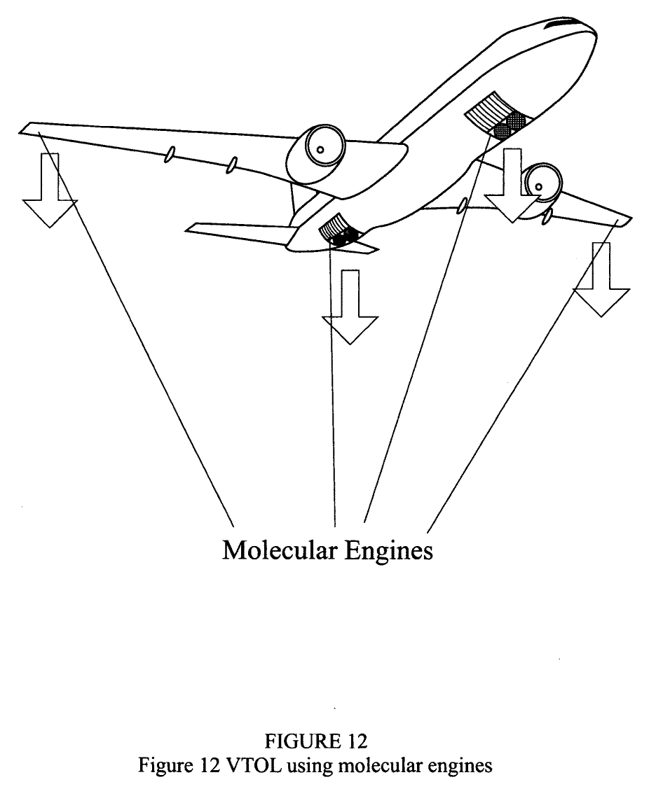

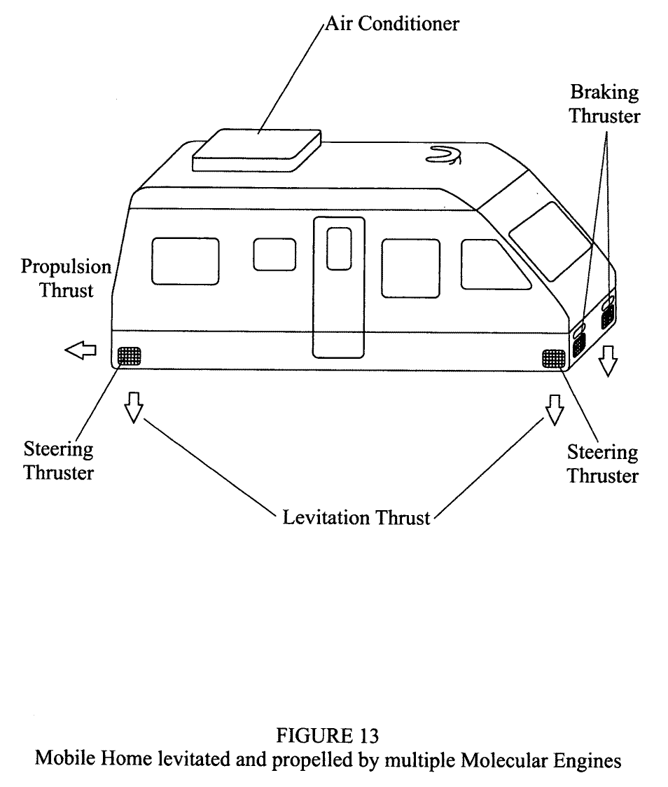

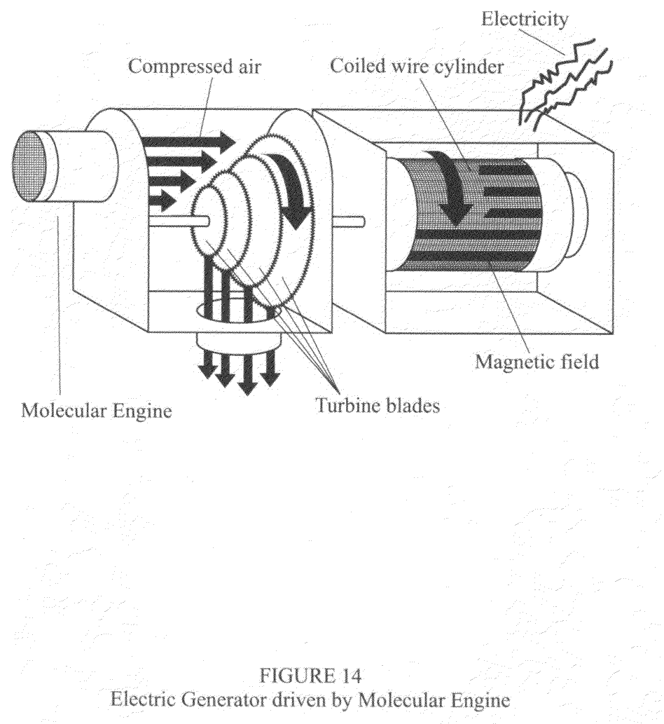

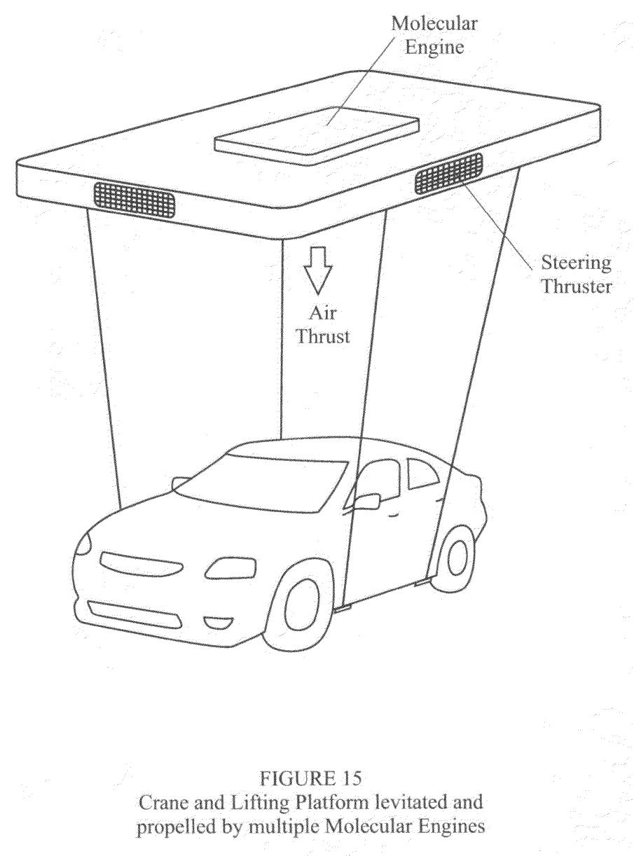

1. A through-hole drilling machine consists of multiple high repetition rate pulsed diode pumped UV lasers (only one is illustrated for clarity) [2] in FIG. 6 (such as from Coherent Inc., Santa Clara, Calif.) situated on separate linear travel guides [3] aiming at a concave focusing mirror in cylindrical length matching the radius of the substrate to be processed [4] as shown in FIG. 6, whereas the pulsed laser beams are focused on to a flat and rotating stainless steel substrate [1] (held down by vacuum from substrate holder [6,7]). Drilling by a programmed variation in the pulsing frequency and pulse width of each laser will achieve first a non-tapered through-hole of 1 to 2 microns in diameter, then a tapered top section with 8 to 10 microns at the top as illustrated in FIG. 5. Typical drilling speed of 10 mm thickness per second can be achieved, so each through-hole can be completed within one tenth of a second with the substrate thickness at less than 1 mm. The substrate is rotated at a rate that matches the drilling rate while the laser itself is translated slowly to create a tightly wound spiral pattern of through-holes on the substrate.
2. The completely drilled partition substrate [11] in FIG. 7 will then move into a vacuum chamber and held in a rotating fixture [10] for deposition of a second material (which can be by evaporation or sputtering of another metal, or electrode discharge to form carbon nanotubes [8 is the deposition source]) while it is heated by halogen lamps [9] as shown in FIG. 7. The deposition rate is precisely controlled to achieve coating of a precise thickness (in sub-nanometer precision), which will produce the through-hole with uniformed diameter with controlled precision range from a few nanometers to a few hundred nanometers.
3. The coated substrate [11] in FIG. 8A will then be diced into the specified dimensions [12] (square, rectangular or circular) to fit into the final engine configuration as illustrated in FIG. 8A.
4. The engine exterior container is formed by two open-ended vertical halves [14] with slits cut into the interior walls [15] for positioning the partitions as shown in FIG. 8B.
5. After the partitions are inserted into one half of the exterior container the other half will be closed and several external bands/locks will hold the two halves together as shown in FIG. 8B.
6. By mechanically fitting an air intake on to the head of stack of the container [13 shows the threads for the air intake regulator [16] to screw on], the molecular engine is thus completed, shown also in FIG. 8B, whereas a filter [17] is added to prevent dust particles clogging the through-holes of the partitions. [18] is electromechanical controller that adjusts the opening of the air intake regulator to meter the amount of air entering into the head of the engine.
7. Other attachments can be machined or bolted to the exterior of the container for connecting the engine to its designed application.

The applications of this invention are virtually endless. Anywhere thrust, propulsion, works, rotation, electricity and gas compression are need, this invention can replace the existing methods without the requirement of any energy source, such as fossil fuel, wind, hydroelectric or direct sunlight. Not only can this invention replace every internal combustion engine used in this world, it also can substitute for any electric driven motors like pumps, compressors, cranes and conveyers. A sample list of applications are illustrated below, the usage of this invention is by no means limited to these areas.

By placing four of the atmospheric molecular engines at the four corners of a platform, the platform can levitate above the ground supporting a weight. Levitating off the ground eliminates the friction provided by the roadway as well as the need of tires. By placing an additional engine horizontally on a 360° horizontal pivot (much like a gimbals) above this platform, you have a moving platform that can carry a weight and travel to very high speed against just the air resistance as well as with capability to turn to any direction. With aerodynamic design, scaling up the thrust of levitation and propulsion molecular engines and by adding more of this type of molecular engines for steering and braking, this becomes a new type of vehicle, recreation vehicle, mobile home, truck, locomotive, personal mover, etc. as illustrated in FIG. 10. By incorporating existing technology of Global Positioning System (GPS) and microprocessors, one can envision a vehicle or a cargo container that can be equipped with levitating and thrust molecular engines to go from one place to another totally under programming control without piloting from a human.

By adding a jet engine (mixing fuel into compressed atmosphere and igniting the mixture) behind this molecular engine as illustrated in FIG. 11, it can produce much more propulsion thrust then just a molecular engine alone can within a unit of time. Furthermore, the molecular engine achieves the compression of air typically done by the first and second stage fans of a regular jet engine, thus these fans and its associated drive shaft and 2^{nd} stage exhaust fan performing the air compression can be eliminated to increase the thrust of the jet engine. This combination can be used to propel an airplane at a faster speed than just using molecular engine alone as well as at higher acceleration. In addition to propulsion, an airplane can add on its wings and fuselage the molecular engines to levitate the airplane. This configuration gives a new type of airplane that can take off and land vertically as well as the ultimate safety of floating without fuel or maintaining an aerodynamic configuration. FIG. 12 presents a conceptual configuration for this new generation of airplanes that employ molecular engines to provide levitation for vertical take off and landing (along for safety) as well as a combination with regular jet engines for thrust.

Coupling the molecular engine of this invention with a turbine to spin an electric generator will produce alternate current (AC) or direct current (DC) electricity depending on the configuration of coil windings as shown in FIG. 14. This new type of generator can be extremely compact in size and easily scaled to supply the proper amount of electricity and voltage for a single residential house, a vehicle, an apartment building, a large commercial building or a skyscraper. Since there are no moving parts in the molecular engine portion, the generator will have excellent reliability to boot, thus making blackouts a thing of the past. This type of electric generator will ultimately eliminate the need of any fossil fuel, nuclear or hydroelectric power plants, transmission grids, and the monthly electric bill for everyone.

Since atmospheric molecules are in the nanometer dimension (i.e. oxygen molecules has a diameter of around 0.3 nm and nitrogen is slightly larger), the molecular engine can be in miniature size to propel a miniature turbine and electric generator to produce DC electricity continuously. It is feasible to construct such a generator in the dimension of a single AAA battery. Consequently, the molecular engine based electric generator can be designed and constructed to replace all chemical batteries as a continuous source of electrical power of desired voltage and current without any charging required. Furthermore, the exhaust air after turning the generator can be used to cool off electronic components. One can certainly achieve true mobility and portability in cell phones, laptop computers, and virtually any electronic devices.

In military applications, not only we can have vertical take off and landing aircraft with the ultimate safety feature of unlimited flight range and survivability of large battle damages, but also an entire aircraft carrier floating on air to any location in the world (over land or sea). Furthermore, any battle weapons and equipment can be self levitated and directed to any designated place quickly including personnel. A fighting platform can be hovered indefinitely at a specific place and height to engage any enemy movement to stop insurgency, terrorist acts, drug or human smuggling. A self-positioning network of explosives can also be floated above an enemy's missiles site or above a city to form a mobile missile defense system. Many other specific applications based on this molecular engine can be designed to better the existing military applications or to create totally new capabilities for the military.

Refrigeration utilizes the phenomenon of heat absorption by a compressed gas undergoing rapid expansion. The molecular engine can accomplish compression of atmospheric gases to several atms. By allowing the compressed atmospheric gases to exit directly into a large room (i.e. expansion space), heat will be absorbed from the room and achieve space cooling effect. Therefore, this invention can be used as an air conditioner to cool a space without compressing any refrigerant and heat exchange coils. Furthermore, by using a miniature version, one can achieve cooling of a person (e.g. head and torso separately) within a garment or hat to enable the person to work and labor in hot environments. However, by expanding the compressed atmosphere gases, produced by a molecular engine, into an expansion space equipped with refrigerant recirculating system and heat exchanges, the refrigerant can then be used to cool a designated space or volume, such as a refrigerator, a freezer or walk-in cooler.

By scaling up to even larger dimensions, the engine can be used as a crane or elevator to lift and move materials with higher degree of freedom than the existing cranes and lifts. By properly sizing and targeted thrust power, the molecular engine from this invention can be used as a prosthetic leg and/or personal carrier to support handicapped or invalid people, as well as postural support in terms of beds and chairs. Robotic development can also be simplified by using this invention for movement, arm/hand actions and power source.

Another application area will be in the separation of trace organic molecules or pollutants from the atmosphere. By coating the partitions with a metal (such as Palladium) or chemical compounds, trace organic molecules or pollutants can be trapped by either adsorption or chemical reaction to the surface of the partitions. After a period of collection, the entire engine can be placed in an oven or immersed in a solvent to remove the trapped molecules. Needless to add, the engine itself is an excellent filter to provide dust free air supply to homes, clean rooms and hospital facilities.

We claim:

1. An engine, deriving its power from the translational energy of atmospheric molecules, is formed by an open ended container within which there are one or more flat and/or curved partitions in parallel with each other, and each partition has numerous through-holes with specifically designed shape aligned from partition to partition to provide a direction on the translation of the atmospheric gas molecules with higher statistical probability than the opposite direction, which is from one side of the partition toward the other side vs. traveling the reverse direction, resulting in more gas molecules moving toward one end of the container vs. the other. This preference in movement due to higher statistical probability results in a pressure difference between the two ends of the container, and this pressure difference can then be used for propelling the container, for rotating a turbine to generate electricity, for performing works, for compressing gases and/or for performing rapid expansion to achieve a cooling effect. By adding an air intake volume controller at atmosphere pressure end of the container, the amount of air entering the container can be regulated, thus controlling the amount of pressure difference can be produced. This container with an air intake controller shall be the atmospheric molecular engine covered in this and subsequent claims.

2. The through-holes with specifically designed shape as described in claim 1 can be in a funnel shape, i.e. one end of the opening is large and gradually taper down to a small diameter hole of a stem tube. The type of taper can be cylindrical or flat sided, and the stem portion can be of any length from zero to many times of the mean free-path length of atmospheric molecules (which is around 60 nanometers at sea level). The diameters at the top of the tapered through-hole and the smaller bottom end holes of the stem tube shall be in the range of few times of the size of nitrogen molecule (which is around 0.3 nanometer) to several tens times of the mean free-path length of atmospheric molecules at sea level; while the length of the through-holes (i.e. from the top of the taper hole to the bottom end-hole of the stem tube) shall be in the range from less than the mean free-path of atmospheric molecules at sea level to many times of the mean free-path length.

3. The partition, which forms the support structure of the through-holes as described in claim 1, can have thickness range from identical to the through-hole length to several hundred times of the through-hole length.

4. To fabricate a partition and its associated through-holes to comply with the description in claim 1, a variety of through-holes forming and/or drilling methods can be utilized, however, due to technical limitations, hole dimensions may have to be modified by thin film deposition and/or nano-particle adherence processes to create the dimension to achieve the effect of producing a higher statistical probability in transitional direction for atmospheric molecules through a partition than the reverse.

5. The method described in claim 4 can be as follows:
(1) One or more pulsed lasers are focused to drill a specified number of taper through-holes or viases on a substrate, which can be circular or rectangular in shape.
(2) The thickness of the substrate is reduced from the opposite side of the taper through-hole or viases either on entire surface area or locally at site opposite to the holes/viases by laser drilling (straight side wall) and/or photolithographic (resist coating, exposure and developing)/etching processes to expose the holes/viases to the right diameter of the stem end.
(3) The substrate then undergoes deposition of layers (thickness per layer in the order of one or more nanometers) of materials (which can be metal, organic polymer, inorganic compounds or nano-material like carbon nanotube) to form the taper through-holes with desired diameters of openings (top and bottom end-hole).
(4) The finished substrate will then be cut into proper dimensions to fit into an open-ended container (cylindrical, rectangular or square) to form the molecular engine.

6. The method described in claim 4 can be also as follows:
(1) An injection mold (father and mother) is fabricated using a combination of photolithographic (resist coating, exposure and developing)/etching processes and an electron beam (EB) machining and/or ion beam machining technique to create densely patterned needles and matching tapered pin holes of a few microns in diameter.
(2) A substrate material such as polycarbonate or other plastics is injection molded to form a partition with densely patterned through-holes.
(3) The substrate then undergoes deposition of layers (thickness per layer in the order of one or more nanometers) of materials (which can be metal, organic polymer, inorganic compounds or nano-material like carbon nanotube) to form the tapered through-holes with desired diameters of openings (top and bottom of the through-hole).
(4) The finished substrate will then be cut into proper dimensions to fit into an open-ended container (cylindrical, rectangular or square) to form the molecular engine.

7. The method described in claim 4 can also be as follows:
(1) A master stamper is fabricated using a combination of photolithographic (resist coating, exposure and developing)/etching processes and an electron beam (EB) machining and/or ion beam machining technique to create a densely patterned needles in a uniformed conical shape (with tapering angle ranging from a few degrees to 45-degree) and the diameter of each needle base can range from 0.5 micron to a few microns.
2) A substrate preform in material such as polycarbonate or other plastics is inserted into the injection molding machine and heated before molding with the master stamper to form a densely patterned conical pits on one of the substrate surface.
(3) The pitted substrate then undergoes photolithographic and etching processes to create a through-hole centered in each pit with diameter of 0.2 micron or smaller.
(4) After the removal of resist material, the resulting substrate will have a densely patterned through-holes and all are in funnel shape.
(5) The substrate may then undergo deposition of layers (thickness per layer in the order of one or more nanometers) of materials (which can be metal, organic polymer, inorganic compounds or nano-material like carbon nanotube) to form the tapered through-holes with desired diameters of openings (top and bottom of the through-hole).
(6) The finished substrate will then be cut into proper dimensions to fit into an open-ended container (cylindrical, rectangular or square) to form the molecular engine.

8. The method described in claim 4 can also be as follows:
(1) Nanoparticles of metal (such as nickel) is coated on the processing side of a substrate (of glass, silicon, ceramic or metal) by chemical vapor deposition, sputtering, electric discharge or plasma enhanced chemical vapor deposition;
(2) Also by chemical vapor deposition, plasma enhanced chemical vapor deposition or electrical discharge, an array of carbon or inorganic nanotubes (diameter range in the tens of nanometers) bounded to one another is grown on the side having nanoparticle coating;
(3) This array of nanotubes will have their opened ends away from the substrate while the other end is tapered down to a small diameter to be sealed by the nanoparticle(s) which was coated over the substrate during the first step.
(4) Micron size holes will then be etched (utilizing photolithographic/etching processes) on the substrate from the opposite side of the nanoparticle coated side until nanotubes are exposed;
(5) Then, the nanoparticle(s) that seal one end of all the nanotubes are etched away to form an array of tapered nanotubes with two open ends while one opening is larger than the other.
(6) Again, the finished substrate is cut to into proper dimensions to fit into an open-ended container to form the molecular engine.

9. The method described in claim 4 can also be as follows:
(1) An array of thick walled inorganic nanotubes bounded to one another is grown on one side of a substrate by electric discharge, chemical vapor deposition or plasma enhanced chemical vapor deposition;
(2) Micron size holes will then be etched (utilizing photolithographic/etching processes) from the opposite side of the substrate until nanotubes are exposed;
(3) Heat treating the end of the nanotubes away from the substrate to shrink the nanotubes' diameters at this end, thus creating a funnel shaped tube with a larger opening at the substrate end.
(4) Again, the finished substrate is cut to into proper dimensions to fit into an open-ended container to form the molecular engine.

10. The air intake volume controller described in claim 1 can derive its action mechanically or electromechanically and be positioned at the head of the stack of partitions to meter the amount of air entering into this end, controlling the amount of pressure difference as well as thrust that can be achieved by the molecular engine. This control also serves as the ultimate on-off switch of the engine. This control may also have filter(s) to prevent dust particles entering into the container.

11. An atmospheric molecular engine as described in claim 1 can further be placed in front of a jet engine or internal combustion engine to provide compressed air to mix with fuel vapor for ignition to produce additional propulsion thrust than just a molecular engine can. This usage may also eliminate the typical air compression intake turbine blades and afterburner turbine blades (which is used to rotate the air intake turbine blades), thus providing added thrust for the jet engine.

12. The utilization of one or more atmospheric molecular engines as described in claim 1 to provide the thrust to propel a vehicle (including all types of cars, trucks, airplanes, ships, trains, buses, motorcycles, recreational vehicles, mobile homes, etc.), a platform or any object.

13. The utilization of one or more atmospheric molecular engines as described in claim 1 to provide the levitation thrust for a vehicle, platform and/or any object to enable it to be moved without surface friction as well as serving the lifting function of a crane or elevator. This levitation thrust can be controlled by height and horizontal leveling sensors (i.e. adjusting the amount of air intake of individual molecular engine to change height and/or leveling of the vehicle, platform and/or object, such as a prosthetic limb and/or robot). Additional atmospheric molecular engines pointing at different directions can be added to provide steering and braking of a levitating vehicle, platform and/or object.

14. The utilization of one or more atmospheric molecular engines as described in claim 1 to provide the levitation thrust for an airplane to enable it take off and land vertically as well as to achieve safe landing in the case of propulsion jet engine failure or damage to the airframe.

15. The utilization of one or more atmospheric molecular engines as described in claim 1 to rotate a turbine to turn an alternate current (AC) and/or direct current (DC) electric generator to produce electricity for all electric power consumption applications.

16. The utilization of a miniaturized version of one or more atmospheric molecular engines as described in claim 1 to rotate a miniaturized DC electric generator or generators to provide continuous and constant DC power source in replacement of a chemical battery or battery pack.

17. The utilization of one or more atmospheric molecular engines as described in claim 1 to compress air and then allow rapid expansion to directly cool a designated space, or integrated with a garment to cool human body/head, or to serve as a cooling source for a recirculating refrigerant to achieve refrigeration of a space like a refrigerator, freezer and/or room.

18. The utilization of one or more atmospheric molecular engines as described in claim 1 to propel and levitate a manned and/or unmanned weapon system, such as bombs, missiles, fighter airplanes, armored fighting vehicles, explosive projectiles, fighting ships, aircraft carriers and floating network of explosive cells for missile defense. The unmanned explosives can thus become a distributed stationary minefield in the sky and/or sequential penetrators of cave or underground bunkers for counter insurgency actions.

19. The utilization of one or more atmospheric molecular engines as described in claim 1 in miniaturized versions to levitate and propel a miniature platform housing surveillance equipment, such as pin-hole camera, microphone and transmitter/receiving devices, to conduct covert surveillance in law enforcement, border patrol and/or military countering terrorism and insurgency applications.

20. The atmospheric molecular engine as described in claim 1 can be further modified by coating its partitions with an adsorbing metal or reactive chemical compounds, which will trap any organic molecules (such as carbon tetrachloride, methane, etc.) or pollutant molecules (like nitrogen oxides, sulfur oxides) by adsorption mechanism or chemical reaction, to serve as air scrubber, air pollutant removing device and/or air filtration system to eliminate pollutants, dust and bacterial particles in air.
